(19) United States
(12) Patent Application Publication
(10) Pub. No.: US 2023/0018321 A1
(43) Pub. Date: Jan. 19, 2023

(54) ELECTRONICALLY-CONTROLLED AXLE BRAKING SYSTEM AND METHOD

(71) Applicant: MAGNA INTERNATIONAL INC., Aurora (CA)

(72) Inventor: Jonathan KING, Novi, MI (US)

(21) Appl. No.: 17/052,283

(22) PCT Filed: May 3, 2019
(86) PCT No.: PCT/US2019/030598

§ 371 Date: Nov. 2, 2020

Related U.S. Application Data
(60) Provisional application No. 62/666,500, filed on May 3, 2018.

(51) Int. Cl. B60T 8/88; B60R 16/023; B62D 65/02

(52) U.S. Cl. CPC B60T 8/885; B60R 16/023; B62D 65/02; B60T 2270/402; B60L 50/60

(57) ABSTRACT

A braking system for a vehicle includes a first axle attached to a chassis and rotatably supporting two front wheels, with a first brake including a first electronic brake controller for controlling application of braking to the front wheels. A second axle rotatably supports two rear wheels and is detachably connected to the chassis and has a second electronic brake controller and a second brake attached thereto for braking the rear wheels. Each of the electronic brake controllers has an independent power source. The system also includes an electronic park brake controller and parking brake. A vehicle control unit is in communication with each of the electronic brake controllers for coordinating control of the braking system. One or more communications network cables, which may be wired or wireless, connect the electronic brake controllers. An electrical connector allows for swapping the second axle, which requires no fluidic connections.

### CROSS-REFERENCE TO RELATED APPLICATIONS

This PCT International Patent Application claims the benefit of U.S. Provisional Patent Application Ser. No. 62/666,500 filed on May 3, 2018, and titled “Electrically-Controlled Axle Braking System And Method”, the entire disclosure of which is hereby incorporated by reference.

### BACKGROUND

Vehicles such as passenger cars are being developed with “plug & drive” capability, whereby an axle of the vehicle may be disconnected and replaced with a replacement axle having a different source of propulsion power. For example, a rear trailing axle (i.e. no power source), may be replaced by an axle that carries a range extender (REX), or an axle with a supplemental battery for propulsion. The rear axle has to have service brakes and a parking brake to meet safety regulations such as U.S. Federal Motor Vehicle Safety Standard (FMVSS) 135. When swapping the rear axle, it is preferable to not break or make any fluidic connections, e.g. hydraulic brake line, fuel lines, engine coolant, etc.

### SUMMARY

A braking system for a vehicle includes a first axle attached to a chassis and having a first brake attached to the first axle for slowing the vehicle by applying a braking force to a first wheel attached to the first axle. The braking system includes a first electronic brake controller for controlling the application of the first brake in response to a first braking signal. A second axle is detachably connected to the chassis and has a second brake attached thereto for slowing the vehicle by applying a braking force to a second wheel attached thereto. The second axle includes a second electronic brake controller for controlling the application of the second brake in response to a second braking signal.

A method of configuring a vehicle is also provided. The method includes swapping-out an original second axle with a replacement second axle by disconnecting an electrical connector coupling one or more communications network cables and an electrical power bus between the chassis of the vehicle and the original second axle, physically removing the original second axle from the chassis, physically attaching the replacement second axle to the chassis, and connecting the electrical connector to establish an electrical connection between the one or more communications network cables and the electrical power bus between the chassis and the replacement second axle.

### BRIEF DESCRIPTION OF THE DRAWINGS

Further details, features and advantages of designs of the invention result from the following description of embodiment examples in reference to the associated drawings.

FIG. 1 is a block diagram of an example braking system of the present disclosure overlaid upon a cutaway top view of a vehicle;

FIG. 2A is a flow chart listing steps in a method of operating a braking system for a vehicle in accordance with the present disclosure;

FIG. 2B is a continuation of the flow chart of FIG. 2A; and

FIG. 2C is a further continuation of the flow chart of FIG. 2A.

### DETAILED DESCRIPTION

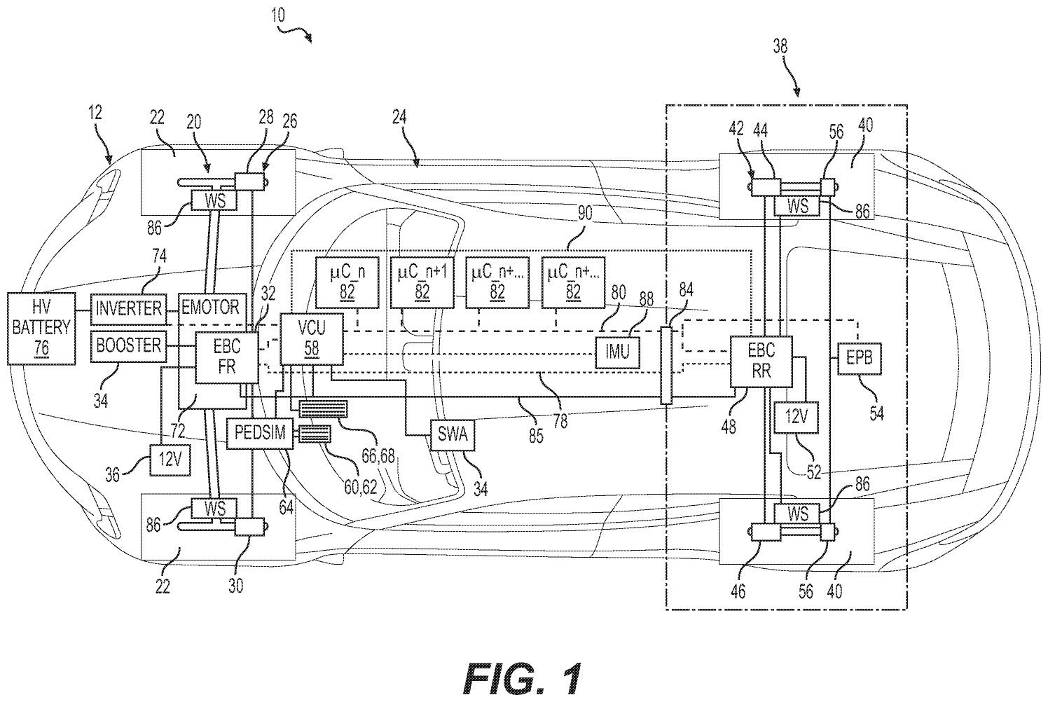

Recurring features are marked with identical reference numerals in the figures, in which a braking system 10 for a vehicle 12 is disclosed. As show in FIG. 1, the vehicle 12 includes a first axle 20 and attached to a chassis 24 and having a first brake 26 attached to the first axle 20 for slowing the vehicle by applying a braking force to a first wheel. In some embodiments, and as shown in FIG. 1, the first axle 20 is a front axle, but in other embodiments, the first axle 20 may be another axle, such as a rear axle. In some embodiments, the first axle 20 may support greater than or less than two wheels. For example, the first axle 20 may support only one wheel in a vehicle having two or three wheels. In some embodiments, the first axle 20 rotatably supports two front wheels 22, and applying the braking force to the first wheel includes applying a braking force to each of the two front wheels 22. The first axle 20 includes one or more shafts, spindles, or other such hardware for rotatably supporting the two front wheels 22. The first axle 20 may also include suspension components such as, for example, springs, shock absorbers, struts, airbags, control arms, sway bars, etc. The first axle 20 may further include one or more powertrain components such as, for example, a differential, electric motor, engine, transmission, etc. The chassis 24 may include a frame, a unibody and/or one or more body panels of the vehicle 12.

As shown in FIG. 1, the first brake 26 includes a right-front brake 28 and a left-front brake 30, each including a rotor and a caliper configured to apply squeezing pressure to a brake pad against the rotor and a first electronic brake controller (EBC) 32 for controlling the application of the first brake 26 in response to a first braking signal by controlling a hydraulic pressure to the calipers. The first brake 26 may be provided with a different configuration. For example, it may include only one of the front brakes 28, 30, such as for vehicular applications having only one front wheel. The first brake 26 may include a brake booster 34 to provide additional actuation force to the right-front brake 28 and to the left-front brake 30. The brake booster 34 may use one of several different energy sources such as electrical, mechanical, pneumatic, or engine vacuum to provide the additional actuation force. Alternatively, the function of the brake booster 34 may be performed by the first electronic brake controller 32.

The braking system 10 includes a first power source 36 coupled to the first electronic brake controller 32 for providing electrical power thereto. In some embodiments, the first power source 36 is a 12V battery, although other power sources are possible including other types of batteries, capacitors, flywheels, etc. The first power source 36 is preferably located proximate to or directly upon the first axle 20 to allow the first electronic brake controller 32 to function, even in case of a loss of communications and/or power from other components in the vehicle 12. In some embodiments, the second power source 52 is configured to provide sufficient power to operate each of the front brakes 28, 30 for slowing the vehicle.

The vehicle 12 further includes a second axle 38, which is detachably connected to the chassis 24. The second axle 38 includes a second brake 42 attached thereto for slowing the vehicle by applying braking force to a second wheel attached thereto. In some embodiments, and as shown in FIG. 1, the second axle 38 is a rear axle, but in other embodiments, the second axle 38 may be another axle, such as a front axle. In some embodiments, the second axle 38 may support greater than or less than two wheels. For example, the second axle 38 may support only one wheel in a vehicle having two or three wheels. In some embodiments, the second axle 38 rotatably supports two rear wheels 40, and applying the braking force to the second wheel includes applying a braking force to each of the two rear wheels 40. As shown in FIG. 1, the second brake 42 includes a right-rear brake 44 and a left-rear brake 46, each including a rotor and a caliper configured to apply squeezing pressure to a brake pad against the rotor and a second electronic brake controller 48 for controlling the application of the second brake 42 in response to a second braking signal, by controlling hydraulic pressure to the calipers.

The braking system 10 includes a second power source 52, which may also be called an independent power source, coupled to the second electronic brake controller 48 for providing electrical power thereto. In some embodiments, the second power source 52 is a 12V battery, although other power sources are possible including other types of batteries, capacitors, flywheels, etc. The second power source 52 is preferably located proximate to or directly upon the second axle 38 to allow the second electronic brake controller 48 to function, even in the event of a loss of communications and/or power from other components in the vehicle 12. In some embodiments, the second power source 52 is configured to provide sufficient power to operate each of the right-rear brake 44 and the left-rear brake 46 for slowing the vehicle.

As also shown in FIG. 1, the braking system 10 includes an electronic park brake controller 54 configured to actuate a parking brake 56 adjacent each of the right-rear brake 44 and the left-rear brake 46 and operably isolated therefrom. In other words, the parking brake 56 is an isolated and redundant system that may provide braking functionality even in case of a loss of one or both of the first brake 26 and/or the second brake 42. The parking brake 56 applies braking force to each of the rear wheels 40 through a different means than the second brake 42, for example, by mechanical actuation.

A vehicle control unit (VCU) 58 is in communication with each of the first electronic brake controller 32 and the second electronic brake controller 48 and the electronic park brake controller 54 for coordinating control of the braking system 10. The VCU 58 may coordinate the use of regenerative braking and/or application of the first brake 26 and the second brake 42 to slow the vehicle 12. The VCU 58 may also control the amount of torque that is delivered to the wheels 22, 40, for example, by controlling the power output of one or more motors and/or engines. A brake pedal 60 is operatively coupled to a brake travel sensor 62 in communication with the vehicle control unit 58 for determining and communicating the position of the brake pedal 60 to the vehicle control unit 58. A pedal simulator 64 may also be included for providing a feedback force through the brake pedal 60 to simulate the feel of a hydraulic brake cylinder, such as the type used in a traditional braking system. Alternatively, a hydraulic master brake cylinder may be actuated by the brake pedal 60. The hydraulic master brake cylinder may actuate the front brake through traditional hydraulic means. The brake travel sensor 62 may take the form of a secondary pressure sensor monitoring hydraulic pressure from a hydraulic master brake cylinder which can give a more accurate representation of requested braking than a sensor that measures linear and/or rotary displacement of the brake pedal 60. Once initial brake pedal travel has been detected, it is sometimes the case that the determined brake torque is calculated from this secondary pressure sensor, as it is more controllable and gives a more natural feel to the operator; (once the brake fluid is compressed, there is little actual pedal travel to measure, but the variation of the pressure in the line between the pedal and the simulator can be measured accurately by the electronic sensor, and with good resolution). Use of a secondary pressure sensor may therefore a more accurate signal of requested braking to be provided to the first electronic brake controller 32 and/or to the VCU 58 for engaging the second brake 42. A hydraulic master cylinder may also provide for a redundant and independent back-up braking, for example, through the use of a hydraulic push-through in the event of a system failure of loss of hydraulic fluid in one the lines.

An accelerator pedal 66 is operatively coupled to an accelerator travel sensor 68 in communication with the vehicle control unit 58 for determining and communicating the position of the accelerator pedal 66 to the vehicle control unit 58. A steering wheel sensor 70 determines and communicates the position of a steering wheel to the vehicle control unit 58.

As also shown in FIG. 1, an electric motor 72 is coupled to the first axle 20 for driving the two front wheels 22. An inverter 74 provides electrical power to the electric motor 72 from a battery pack 76. The VCU 58 is in communication with the inverter 74 to control the transfer of energy to and from the electric motor 72.

A first communications network cable 78 connects the first electronic brake controller 32 and the second electronic brake controller 48. In some embodiments, and as shown in FIG. 1, the first communications network cable 78 is a private network connected only to the electronic brake controllers 32, 48 and the vehicle control unit 58. The first communications network cable 78 may be configured as, for example, a high-speed controller area network (CAN) network. The first communications network cable 78 may be configured to transmit the second braking signal from the first electronic brake controller 32 to the second electronic brake controller 48. A second communications network cable 80 connects the first electronic brake controller 32 and the second electronic brake controller 48 and the vehicle control unit 58 and with a plurality of other microcontrollers 82, dedicated to other functions in the vehicle 12. The second communications network cable 80 may be configured as, for example, a controller area network (CAN) network.

An electrical connector 84 is provided for coupling the communications network cables 78, 80 and an electrical power bus 85 between the second axle 38 and the chassis 24. This allows the second axle 38 to be relatively easily swapped-out for replacement with a different second axle 38. For example, for replacing an unpowered rear axle with one having an auxiliary electric motor and/or an internal combustion engine and/or additional battery storage capacity. According to an aspect, there may be no fluidic connections between the chassis 24 and the second axle 38. By making the connections between the second axle 38 and the chassis 24, the second axle can be swapped-out without needing to catch or drain any fluids. This allows the second axle 38 to be swapped-out in an easy, clean, and inexpensive process with reduced environmental impacts when compared with processes that involve draining or spilling fluids such as hydraulic brake fluid.

As also shown in FIG. 1, wheel speed sensors 86 are provided for sensing the rotational velocity of each of the front wheels 22 and each of the rear wheels 40 and communicating the associated wheel speed to one of the microcontrollers 82. Each of the wheel speed sensors 86 communicate the associated wheel speed to the VCU 58 and/or to a dedicated ABS controller or a traction control system controller. An inertial measurement unit (IMU) 88 attached to the chassis 24 and in communication with the VCU 58 for communicating information regarding inertial movement of the vehicle 12. The IMU 88 may report acceleration (in up to 3 axes), tilt (about up to 3 axes), and/or angular velocity (about the 3 axes).

In some embodiments, and as shown in FIG. 1, each of the wheel speed sensors 86 associated with the second axle 38 may be electrically connected to the second electronic brake controller 48. Signals from the wheel speed sensors 86 associated with the second axle 38 may be communicated from the second electronic brake controller 48 to the vehicle control unit 58 and/or to one or more of the other microcontrollers 82, via the first or second communication networks 78, 80. This configuration may allow signals from the wheel speed sensors 86 associated with the second axle 38 to be monitored by the vehicle control unit 58 and/or one or more of the other microcontrollers 82 without additional cables or connections between the second axle 38 and the chassis 24 of the vehicle 12.

As also shown in FIG. 1, the braking system 10 also includes a wireless communications path 90 between the vehicle control unit 58 and the second electronic break controller 48 which includes antennas, receivers, transmitters, and/or transceivers at each of those devices to establish wireless communications therebetween. The wireless communications path 90 may be used instead of a wired data communication network, such as one or both of the first or second communication networks 78, 80. Alternatively, the wireless communications path 90 may be used in addition to one or more wired ones of the communication networks 78, 80 between the vehicle control unit 58 and the second electronic break controller 48 and may, for example allow for full function or for communication of a faulted status in case of an interruption or loss of communication via one or more wired ones of the communication networks 78, 80.

The braking system 10 therefore provides a separate service braking module 32, 48 on each axle 20, 38, whereby the only functional connection between the units 32, 48 is by electrical connection for power and communications. In other words, the braking system 10 of the present disclosure may provide for service braking on the second axle 38 without any fluidic or mechanical linkage connections to service braking components disposed upon the chassis 24 of the vehicle 12, such as the brake pedal 60 or the first electronic brake controller 32 or to a master brake cylinder. This arrangement may facilitate swapping-out the second axle 38 with a replacement second axle 38.

The operation of the braking system 10 would preferably be indistinguishable from a conventionally operated and controlled electro-hydraulic braking system while providing all conventional safety features, like ABS, ESP, TCS, etc. The vehicle 12 is preferably electrically propelled via the front axle. Using a “strong” braking energy recuperation strategy, it is anticipated that a majority of the braking torque can be supplied by conversion of kinetic energy to electrical energy via the electric motor system (regen braking). The remainder of the desired braking torque would be realized via the service (friction) brakes. This braking system 10 would be compatible with all levels of Advanced Driver Assistance Systems (ADAS) functionality as described by SAE J3016, and meet the requirements of the highest Automotive Safety Integrity Level (ASIL-D).

According to an aspect, either one of the front axle or the rear axle or both axles may be configured as the second axle 38 configured for swapping-out. For example, either or both of the front axle and the rear axle may be equipped with an electrical connector 84 and without any fluidic connections to the chassis 24. According to an aspect, a plurality of different second axles 38 may be attached to the vehicle 12 at any given time. The different second axles 38 may include, for example, an unpowered second axle without a source of driving torque. Such an unpowered second axle may be a basic axle without any driving hardware and without any energy storage capacity.

In some embodiments, the second axles 38 may include an electrically powered second axle having a second electric motor (not shown in the figures) configured to supply a driving torque to the second wheel. An electrically powered second axle may provide all wheel drive capability to a vehicle 12 that previously was driven only by wheels on the first axle 20.

In some embodiments, the second axles 38 may include an engine-powered second axle having an internal combustion engine. In some embodiments, such an internal combustion engine may be configured to supply a driving torque to the second wheel. In some embodiments, an engine-powered second axle may be configured as a range extender (REX), which may generate electricity for charging the battery pack 76 and/or for supplying power to one or more electric motors 72.

In some embodiments, the second axles 38 may include a supplemental storage second axle having a battery, such as a high-voltage battery configured to provide power to one or more electric motors 72, which may be configured to drive one or more of the front wheels 22 and/or one or more of the rear wheels 40.

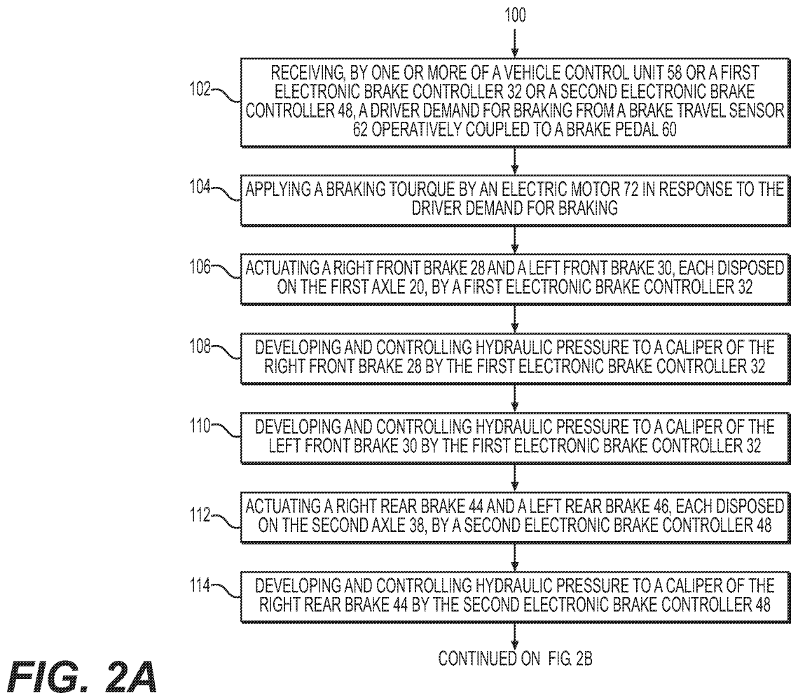

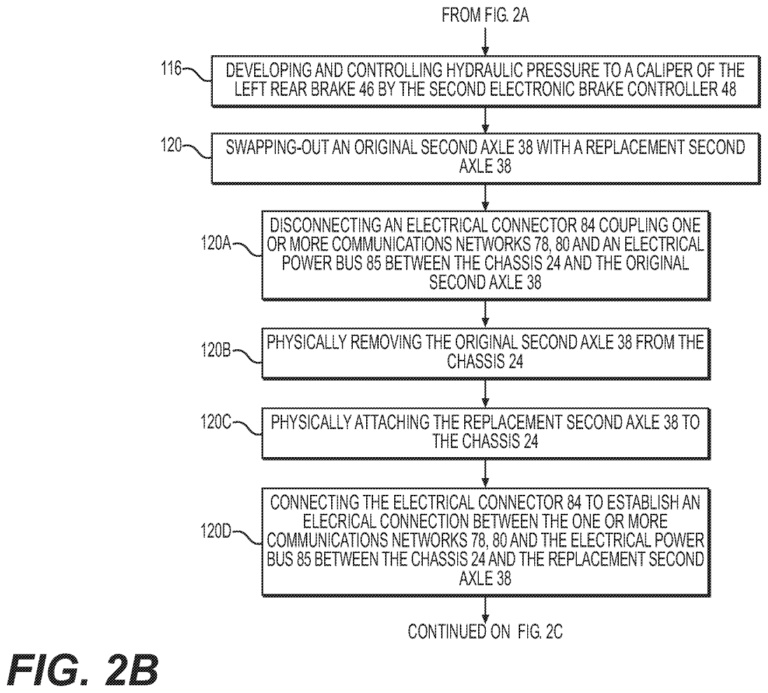

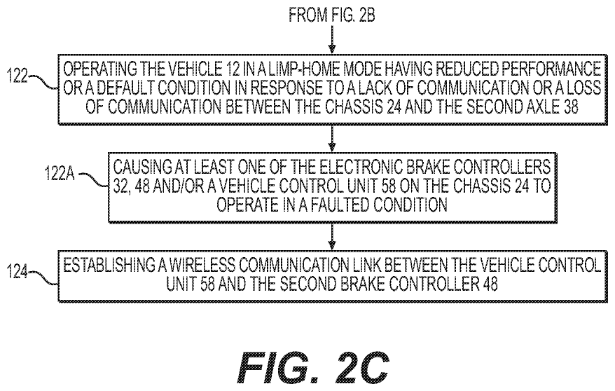

As described in the flow charts of FIGS. 2A-2C, a method 100 of operating a braking system 10 for a vehicle 12 having a chassis 24 and including a first axle 20 and a second axle 38 is also provided. The method 100 includes receiving, by one or more of a vehicle control unit 58 or a first electronic brake controller 32 or a second electronic brake controller 48, a driver demand for braking from a brake travel sensor 62 operatively coupled to a brake pedal 60 at step 102. In practice, the vehicle control unit 58 may directly receive a signal representative of the driver demand for braking from the brake travel sensor 62. The vehicle control unit 58 may then send a separate signal to each of the electronic brake controllers 32, 48, which may be based upon the first signal, but which may have different characteristics. For example, the vehicle control unit 58 may not signal the electronic brake controllers 32, 48 to activate if the driver demand for braking is below a predetermined threshold amount. Instead, the vehicle control unit 58 may rely upon regenerative braking to satisfy requests for light braking. For braking above that predetermined threshold amount, the vehicle control unit 58 may signal the electronic brake controllers 32, 48 to begin braking by applying a braking force that is proportional to the demand for braking that is in excess of the predetermined threshold braking amount.

The method 100 also includes applying a braking torque by an electric motor 72 in response to the driver demand for braking at step 104. This step is, in part, described above and may depend on the amount of the driver demand for braking and/or other factors such as, for example, the charge state of the battery pack, or the distance to an obstacle in front of the vehicle 12.

The method 100 also includes actuating a right front brake 28 and a left front brake 30, each disposed on the first axle 20, by a first electronic brake controller 32 at step 106. The use of such service brakes, also called friction brakes, may be necessary to supplement the braking capability of the powertrain components used for regenerative braking.

The method 100 also includes developing and controlling hydraulic pressure to a caliper of the right front brake 28 by the first electronic brake controller 32 at step 108. This step may also be performed by hydraulic drum brakes by moving a brake shoe within a drum attached to the right one of the front wheels 22.

The method 100 also includes developing and controlling hydraulic pressure to a caliper of the left front brake 30 by the first electronic brake controller 32 at step 110. This step may also be performed by hydraulic drum brakes by moving a brake shoe within a drum attached to the left one of the front wheels 22.

The method 100 also includes actuating a right rear brake 44 and a left rear brake 46, each disposed on the second axle 38, by a second electronic brake controller 48 at step 112. This step may also be performed by hydraulic drum brakes on the second axle 38 instead of disk brakes.

The method 100 also includes developing and controlling hydraulic pressure to a caliper of the right rear brake 44 by the second electronic brake controller 48 at step 114. This step may also be performed by hydraulic drum brakes by moving a brake shoe within a drum attached to the right one of the rear wheels 40.

The method 100 also includes developing and controlling hydraulic pressure to a caliper of the left rear brake 46 by the second electronic brake controller 48 at step 116. This step may also be performed by hydraulic drum brakes by moving a brake shoe within a drum attached to the left one of the rear wheels 40.

The method 100 also includes swapping-out an original second axle 38 with a replacement second axle 38 at step 120. This step 120 allows the rear axle 38 of the vehicle 12 to be disconnected and replaced with an axle including a different source of propulsion power. For example, a rear trailing axle (i.e. no power source), may be replaced by an axle that carries a range extender (REX) such as an internal combustion engine, or an axle with a supplemental battery for propulsion.

Step 120 includes disconnecting an electrical connector 84 coupling one or more communications network cables 78, 80 and an electrical power bus 85 between the chassis 24 and the original second axle 38 at substep 120A; physically removing the original second axle 38 from the chassis 24 at substep 120B; physically attaching the replacement second axle 38 to the chassis 24 at substep 120C; and connecting the electrical connector 84 to establish an electrical connection between the one or more communications network cables 78, 80 and the electrical power bus 85 between the chassis 24 and the replacement second axle 38 at substep 120C. In some embodiments, the electrical connector 84 may include two or more physical connections, such as plugs, receptacles, and/or wire connectors. In some embodiments, physically removing the original second axle 38 and physically attaching the replacement second axle 38 to the chassis 24 may include releasing and securing a physical linkage, respectively. The physical linkage may include, for example, one or more latches, nuts, bolts, and/or other fasteners.

The method 100 also includes operating the vehicle 12 in a limp-home mode having reduced performance or a default condition in response to a lack of communication or a loss of communication between the chassis 24 and the second axle 38 at step 122. Step 122 includes causing each of the electronic brake controllers 32, 48 and a vehicle control unit 58 located on the chassis 24 to operate in a faulted condition at substep 122A.

The method 100 also includes establishing a wireless communication link between the vehicle control unit 58 and the second brake controller 48 associated with the second axle 38 at step 124. The wireless communication link allows the communication of operational commands and/or a faulted status message between the vehicle control unit 58 and the second brake controller 48 without a functioning wired connection therebetween. The wireless communication link may be used, for example, in response to a lack of communication or a loss of communication on a wired connection between the chassis 24 and the second axle 38, such as one or more of the communications network cables 78, 80.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A braking system for a vehicle comprising:
a first axle attached to a chassis and having a first brake attached thereto for slowing the vehicle by applying a braking force to a first wheel attached to said first axle;
a first electronic brake controller for controlling the application of said first brake in response to a first braking signal;
a second axle detachably connected to the chassis and having a second brake attached thereto for slowing the vehicle by applying a braking force to a second wheel attached thereto; and
said second axle including a second electronic brake controller for controlling the application of said second brake in response to a second braking signal.

2. The braking system of claim 1, wherein there are no fluidic connections between said chassis and said second axle.

3. The braking system of claim 1, wherein first axle is a front axle of the vehicle and the second axle is a rear axle of the vehicle.

4. The braking system of claim 1, wherein the second axle includes an electronic park brake controller separate from the second brake controller and configured to actuate a parking brake to apply a braking force to the second wheel, with the parking brake operably isolated from the second brake.

5. The braking system of claim 1, wherein the second axle includes an independent power source for providing electrical power to the second electronic brake controller independent of an electrical power bus from the chassis.

6. The braking system of claim 1, further comprising a communications network cable configured to transmit the second braking signal from the first electronic brake controller to the second electronic brake controller.

7. The braking system of claim 6, further comprising an electrical connector configured to selectively decouple the communications network cable from the second axle for detaching the second axle from to the chassis.

8. The braking system of claim 1, wherein the second axle is one of a plurality of two or more different second axles, each having a different configuration.

9. The braking system of claim 8, wherein the plurality of two or more different second axles includes an unpowered second axle without a source of driving torque.

10. The braking system of claim 8, wherein the plurality of two or more different second axles includes an electrically powered second axle having a second electric motor configured to supply a driving torque to the second wheel.

11. The braking system of claim 8, wherein the plurality of two or more different second axles includes an engine powered second axle having an internal combustion engine.

12. The braking system of claim 8, wherein the plurality of two or more different second axles includes a supplemental storage second axle having a battery configured to provide power to an electric motor.

13. A method of configuring a vehicle comprising:
swapping-out an original second axle with a replacement second axle by:
disconnecting an electrical connector coupling one or more communications network cables and an electrical power bus between a chassis of the vehicle and the original second axle;
physically removing the original second axle from the chassis;
physically attaching the replacement second axle to the chassis; and
connecting the electrical connector to establish an electrical connection between the one or more communications network cables and the electrical power bus between the chassis and the replacement second axle.

14. The method of claim 13, further including:
operating the vehicle in a limp-home mode having reduced performance or a default condition in response to a lack of communication or a loss of communication between the chassis and the second axle; and
wherein operating the vehicle in a limp-home mode includes at least one of: causing a first electronic brake controller disposed on the first axle to operate in a faulted condition, or causing a second electronic brake controller disposed on the second axle to operate in a faulted condition, or causing a vehicle control unit disposed on the chassis to operate in a faulted condition.

15. The method of claim 13, further including:
establishing a wireless communication between the vehicle control unit and the second brake controller to communicate at least one of an operational command or a faulted status message therebetween, and without a wired connection therebetween.

16. The method of claim 13, wherein the original second axle and the replacement second axle each have a different configuration.

17. The braking system of claim 1, wherein the vehicle is a passenger car, wherein said first wheel attached to said first axle is one of two front wheels, and wherein said second wheel attached to said second axle is one of two rear wheels.

18. The braking system of claim 5, wherein the second wheel is one of two second wheels attached to the second axle;
wherein the second brake is one of two second brakes, each of the two second brakes configured to provide a braking force to a corresponding one of the two second wheels; and
wherein the independent power source is configured to provide power to operate each of the two second brakes to slow the vehicle in case of a loss of communications or a loss of power to the second electronic brake controller.

19. The braking system of claim 8, wherein the plurality of two or more different second axles includes a basic axle without a source of driving torque and without any energy storage capacity.

20. The braking system of claim 11, wherein the internal combustion engine is configured to generate electricity for charging a battery or for supplying electrical power to an electric motor for propelling the vehicle.
